(19) United States
(12) Patent Application Publication
(10) Pub. No.: US 2023/0237513 A1
(43) Pub. Date: Jul. 27, 2023

(54) SERVER AND PROGRAM FOR A STORE INTRODUCTION SYSTEM

(71) Applicant: TOSHIBA TEC KABUSHIKI KAISHA, Tokyo (JP)

(72) Inventor: Takuya TAKASU, Shizuoka Shizuoka (JP)

(21) Appl. No.: 17/988,398

(22) Filed: Nov. 16, 2022

(30) Foreign Application Priority Data
Jan. 25, 2022 (JP) 2022-009667

(51) Int. Cl. G06Q 30/02

(52) U.S. Cl. CPC G06Q 30/0201

(57) ABSTRACT

According to one embodiment, a server for a store introduction system includes communication interfaces to connect to a member site server and a plurality of store servers. A control unit with a processor and memory collects customer information of a customer provided to the member site server and sales transaction related information from a store server. The control unit also collects store information from the store servers indicating commodities sold at each store and the customers of each store and performs a matching process between the customer and the stores based on purchase preferences of the customer indicated in the customer information and characteristics of stores indicated in the store information. A result of the matching process is transmitted to the member site server.

### CROSS-REFERENCE TO RELATED APPLICATION

This application is based upon and claims the benefit of priority from Japanese Patent Application No. 2022-009667, filed Jan. 25, 2022, the entire contents of which are incorporated herein by reference.

### FIELD

Embodiments of the present invention relate to a server and a program related to a store introduction system by which stores are introduced or suggested to potential customers.

### BACKGROUND

There are many different types of stores or consumer-facing businesses such as supermarkets, convenience stores, mass retailers, specialty stores, and restaurants. Each such store may operate according to tastes and features specific to the store itself. For example, a store may have a large number of unique types of commodities and may thus be frequented by customers who want to purchase those particular types of commodities.

However, since the needs of customers are diverse, any particular store may not always be good for everyone. Thus, although a store may generally have a good reputation by word of mouth and public reputation, some customers, even those with tastes generally corresponding to the store, might not ever shop at the store. Typically, a customer cannot actually determine whether the store is suitable for himself/herself until the customer comes to the store and uses the store.

### BRIEF DESCRIPTION OF THE DRAWINGS

FIG. 1 is a diagram illustrating an example of a store introduction system including a server according to an embodiment.

FIG. 2 is a block diagram illustrating an example of a hardware configuration of a mobile terminal.

FIG. 3 is a block diagram illustrating an example of a hardware configuration of a store server.

FIG. 4 is a block diagram illustrating an example of a hardware configuration of a data server.

FIG. 5 depicts a configuration of a member master.

FIG. 6 depicts a configuration of a store master.

FIG. 7 depicts a configuration of a commodity master.

FIG. 8 is a flowchart of a control process of a mobile terminal.

FIG. 9 is a flowchart of a control process of a store server.

FIG. 10 depicts functional aspects of a data server.

FIG. 11 is a flowchart of a control process of a data server.

FIG. 12 is a pie chart illustrating an example of expanded store information.

FIG. 13 is a pie chart illustrating an example of expanded customer information.

FIG. 14 is a pie chart illustrating an example expanded commodity information.

### DETAILED DESCRIPTION

An object to be solved by the present invention is to provide a server and a program capable of suggesting a useful store to a customer.

In general, according to one embodiment, a server for a store introduction system includes a first communication interface configured to connect to a member site server, a second communication interface configured to connect to a plurality of store servers, and a control unit. The control unit includes a processor and a memory unit and configured to: collect customer information of a customer, the customer information being provided by the customer to the member site server or transaction related information from a store server in the plurality of store servers, the transaction related information reflecting a sales transaction of the customer at a store associated with the store server; collect store information from the plurality of store servers, the store information indicating commodities sold at each store and customers of each store; perform a matching process between the customer and the stores associated with the plurality of store servers based on purchase preferences of the customer indicated in the customer information and characteristics of stores indicated in the store information; and transmit information indicating a result of the matching process to the member site server.

Hereinafter, certain non-limiting example embodiments of a server and a program will be described with reference to the accompanying drawings.

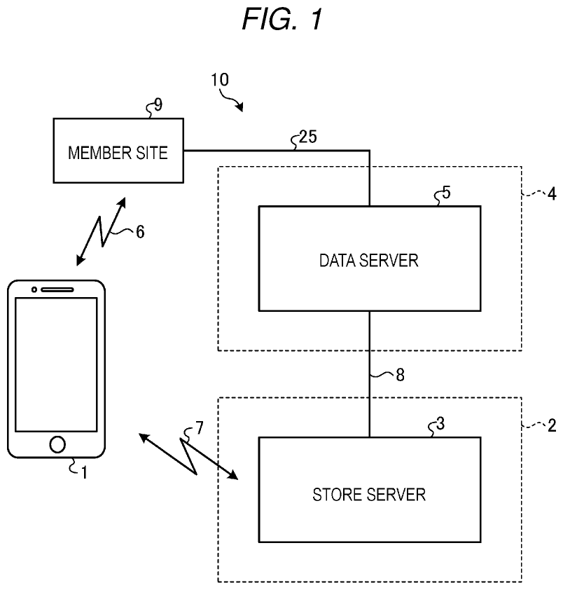

FIG. 1 is a diagram illustrating an example of a store introduction system 10 according to an embodiment. The store introduction system 10 is a system that introduces a customer, who is a member of the system, to a store that might be suitable (useful) the customer (member) in view of information regarding the tastes and preferences of the user obtained from purchase history information including information about the stores at which the customer has previously purchased items.

As illustrated in FIG. 1, the store introduction system 10 includes a mobile terminal 1, a store server 3, and a data server 5. The mobile terminal 1 is preferably a device that can be carried by the customer, such as a mobile phone, a smartphone, a tablet terminal, or a personal digital assistant (PDA), but may be a device that is provided at home or the like, for example, a personal computer (PC). The mobile terminal 1 in the present example is a terminal carried by the customer.

The mobile terminal 1 has a wireless communication function. The mobile terminal 1 can communicate with the store server 3 via a wireless communication connection 7. The mobile terminal 1 can communicate with the data server 5 via a wireless communication connection 6. The mobile terminal 1 transmits/receives information and data to/from the store server 3 and the data server 5 by wireless communication.

The mobile terminal 1 receives payment information from the store server 3. In addition, the mobile terminal 1 can receive inputs of information and transmits information (for example, basic customer information and payment information) to the data server 5 via a membership site 9.

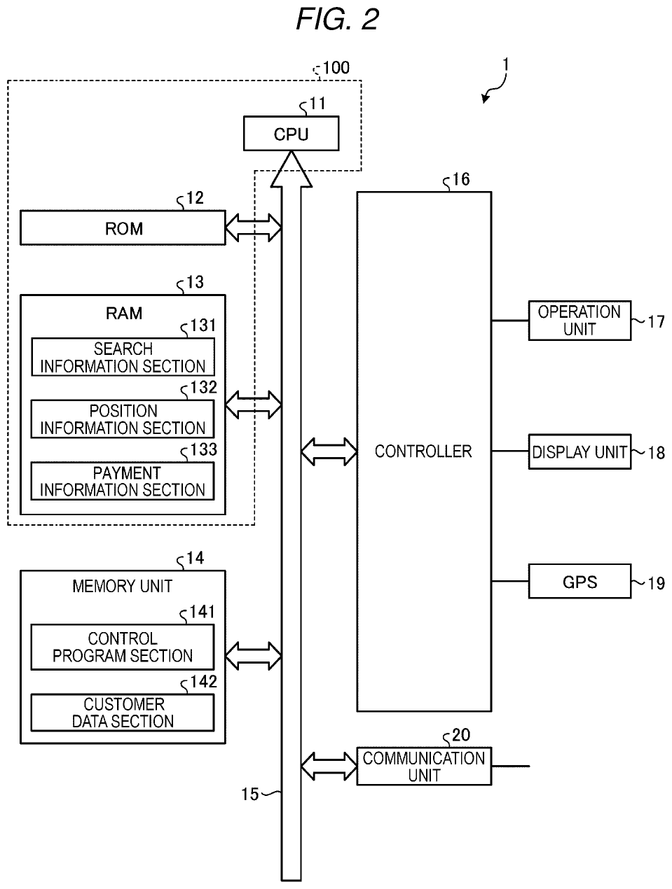

The mobile terminal 1 includes a global positioning system (GPS) 19 (see FIG. 2. The mobile terminal 1 acquires data related to a current position of the mobile terminal 1 by the GPS 19. The mobile terminal 1 transmits the acquired position information along with the payment information to the data server 5 via the membership site 9.

The mobile terminal 1 stores a customer ID (Identification, customer identification information, a member ID) that uniquely identifies the customer who carries the mobile terminal 1. The mobile terminal 1 also stores basic customer information (e.g., age, gender, home address, and the like). The mobile terminal 1 transmits the basic customer information to the data server 5 via the membership site 9. The membership site 9 and the data server 5 are connected to each other via a communication connection 25. The communication connection 25 can use a dedicated line or a public line.

An application (software program or “app”) having a function of transmitting the customer ID, the basic customer information, the payment information, and the store ID (store identification information that identifies a store 2 where a transaction was made) to the data server 5 is installed in the mobile terminal 1.

The store server 3 tracks (manages) sales information about the commodities at the store 2. The store server 3 stores commodity information (e.g., a commodity name, a commodity price, and the like) and settlement information (e.g., sale transaction total amount information, a tax amount, a transaction number (transaction identification information that identifies each particular sales transaction, and the like) related to the sales of commodities and services at the store 2. Such information regarding sales is provided by a connected point-of-sales (POS) terminal at the store 2. It is noted that this sales-related information (a commodity code, a price of each commodity, a transaction number, and the like) regarding commodities (or services) purchased by customers can be referred to in this context as payment information or sales information.

The store server 3 is installed in the store 2. The store 2 is a store of a company participating in the store introduction mechanism provided by the store introduction system 10. The store server 3 collects the commodity information and the settlement information for the store 2. In addition, the store server 3 stores information about the store 2, referred to as basic store information including such things as designations of store genre/type, available commodities, access information (store physical address), customers ID of each customer who has used the store 2, and the like 2. The store server 3 is connected to the data server 5 via a wired or wireless communication connection 8. The store server 3 transmits the basic store information together with the store ID to the data server 5 via the communication connection 8. It is noted that the communication expanded 8 can use a dedicated line or a public line.

When a customer purchases a commodity at the store 2 (shops at the store), the store server 3 transmits the payment information for the transaction together with the store ID of the store 2 to the mobile terminal 1.

The data server 5 is installed in, for example, a data center 4. The data center 4 may be outside the store 2 or inside the store 2 (and is located outside the store 2 in the present embodiment).

The data server 5 receives (collects) the basic customer information (age, gender, and residential place), the current position of the mobile terminal 1, the store ID of the store 2, the payment information related to previous transactions as well search conditions provided by the customer, and taste settings (user settings) previously entered by the customer from the mobile terminal 1. The received information is accumulated in the data server 5. The data server 5 may categorize customer attributes (age, gender, residential place, activity range, frequently used stores, frequently purchased commodities (or services), favorite store genre, and the like based on the accumulated customer information and accumulates information for each customer's (customer ID) attributes.

The data server 5 also receives (collects) information about stores (e.g., available commodities (or services), price ranges, location, and the like from the store servers 3. The data server 5 generates additional store information (which is information obtained by linking or analyzing from customers regarding the purchases and the like in the usage history of the customers. For example, additional information about each store 2 may indicate popular commodities that are purchased at each particular store 2, demographics or other common characteristics of the customers who frequent the store 2, stated preferences of the customers of the store 2, and/or noted commonalities between different stores 2 that may be derived from accumulated basic store information or previously generated additional store information in conjunction with accumulated customer information.

When a customer searches for a store by using the membership site 9, the data server 5 performs a matching process of extracting the stores with as many matching as many search criteria (search settings) as possible based on the customer information and the store information. For example, a list of stores evaluated as best matching the search settings amongst all stores 2 can be generated.

In addition, the data server 5 performs data mining and extracts stores that are frequently used by other members having many common points, stores in different categories but otherwise matching a favorite genre/type of the customer, and the like. A list of the extracted stores is transmitted to the membership site 9. The mobile terminal 1 accesses the membership site 9 and browses the store list transmitted from the data server 5.

The membership site 9 is accessible via the Internet for customers who are members. The membership site 9 can implemented as a server accessible by registered members of the store introduction system 10. Each customer who is a member can access a page dedicated to the customer on the membership site 9 by installing an application on the mobile terminal 1.

FIG. 2 is a block diagram illustrating an example of a hardware configuration of a mobile terminal 1. As illustrated in FIG. 2, the mobile terminal 1 includes a central processing unit (CPU) 11 (processor), a read only memory (ROM) 12, a random access memory (RAM) 13, a memory unit 14, and the like. The CPU 11, the ROM 12, the RAM 13, and the memory unit 14 are connected to each other via a bus 15. The CPU 11, ROM 12, and RAM 13 configure a control unit 100 that executes a control process according to a control program.

The RAM 13 includes a search information section 131, a position information section 132, and a payment information section 133. The search information section 131 stores the search conditions input via operation of an operation unit 17. The position information section 132 stores the current position information of the mobile terminal 1 as detected by the GPS 19. The payment information section 133 stores the information related to a sales transaction at a store 2.

The memory unit 14 can include a non-volatile memory such as a hard disk drive (HDD) or a flash memory that retains stored information even when power is turned off. The memory unit 15 has a control program section 141 that stores the control program that controls operations of the mobile terminal 1 and a customer data section 142 that stores the basic customer information input by the customer.

The control unit 100 is connected to an operation unit 17, a display unit 18, and a GPS 19 via the bus 15 and a controller 16. The controller 16 receives instructions from the control unit 100 and controls the operation unit 17, the display unit 18, and the GPS 19. However, for convenience of description in the following, the particular control processes performed by the controller 16 may be stated as being caused, and thus performed, by the control unit 100.

The operation unit 17 is, for example, a keyboard or a touch panel. The display unit 18 is, for example, a liquid crystal display and displays information to the operator of the mobile terminal 1.

The control unit 100 is connected to a communication unit 20 via the bus 15. The communication unit 20 is connected to the store server 3 via the wireless communication connection 7 and transmits/receives information to/from the store server 3. The communication unit 20 can also be connected to the membership site 9 via the wireless communication connection 6 and transmits/receives information to/from the membership site 9.

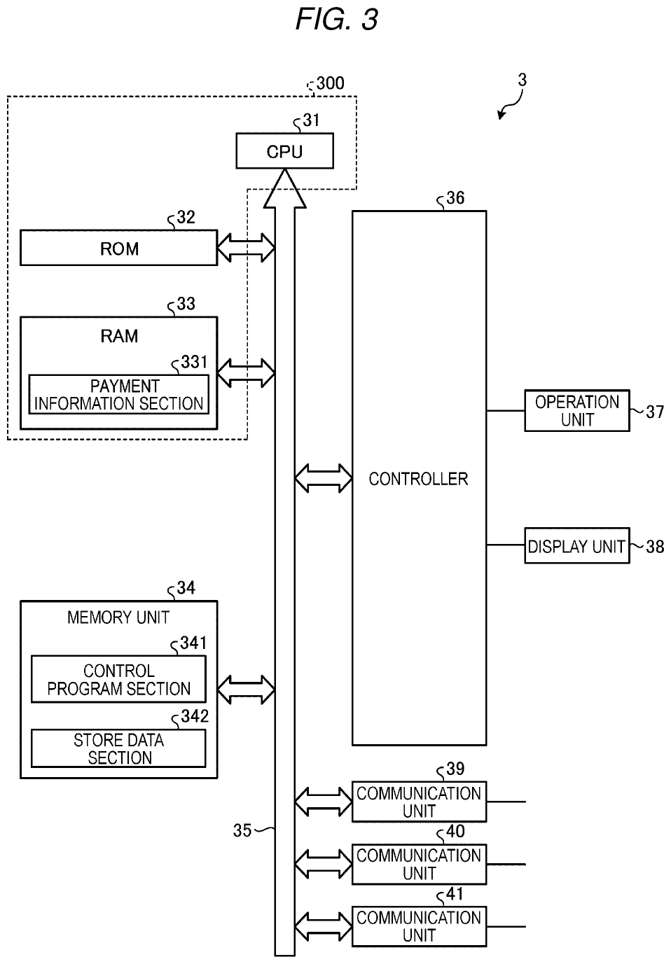

FIG. 3 is a block diagram illustrating an example of a hardware configuration of the store server 3. As illustrated in FIG. 3, the store server 3 includes a CPU 31 which is an example of a processor, a ROM 32, a RAM 33, a memory unit 34, and the like. The CPU 31, the ROM 32, the RAM 33, and the memory unit 34 are connected to each other via a bus 35. The CPU 31, the ROM 32, and the RAM 33 configure a control unit 300 that executes a control process of the store server 3 according to a control program.

The RAM 33 includes a payment information section 331. The payment information section 331 stores the payment information related to the customer's transactions by transaction number (transaction identification information that identifies the transaction).

The memory unit 34 includes a non-volatile memory such as an HDD or a flash memory that retains stored information even when power is turned off, and includes a control program section 341 that stores a control program that controls the store server 3 and a store data section 342 that stores the store ID of the store 2 in which the store server 3 is installed and the basic store information for store 2.

The control unit 300 is connected to an operation unit 37 and a display unit 38 via the bus 35 and the controller 36. The controller 36 receives instructions from the control unit 300 and controls the operation unit 37 and the display unit 38. However, for convenience of description in the following, the particular control processes performed by the controller 36 may be stated as being caused, and thus performed, by the control unit 300.

The operation unit 37 is, for example, a keyboard or a touch panel. The display unit 38 is, for example, a liquid crystal display.

The control unit 300 is connected to the communication unit 39, the communication unit 40, and the communication unit 41 via the bus 35. The communication unit 39 is connected to the mobile terminal 1 via the wireless communication connection 7. The communication unit 40 is connected to the data server 5 via the communication connection 8. The communication unit 41 is connected to a POS terminal to receive transaction-related commodity information and settlement information from the POS terminal.

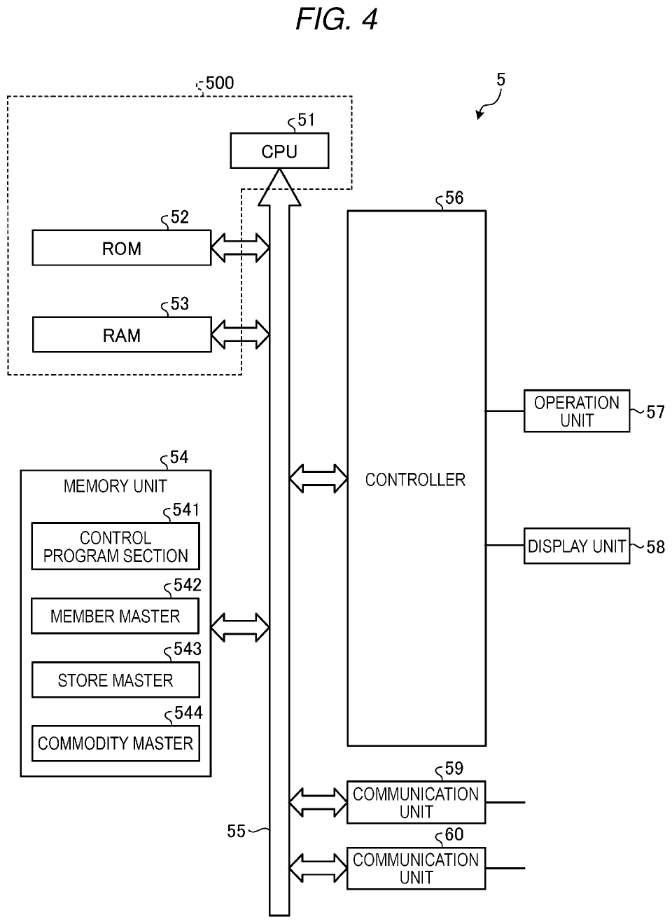

FIG. 4 is a block diagram illustrating an example of a hardware configuration of the data server 5. As illustrated in FIG. 4, the data server 5 includes a CPU 51, a ROM 52, a RAM 53, a memory unit 54, and the like. The CPU 51, the ROM 52, the RAM 53, and the memory unit 54 are connected to each other via a bus 55. The CPU 51, the ROM 52, and the RAM 53 configure a control unit 500 that executes a control process of the data server 5 according to a control program.

The memory unit 54 includes a non-volatile memory such as an HDD or a flash memory that retains stored information even when power is turned off and includes a control program section 541 that stores the control program that controls the data server 5, a member master 542, a store master 543, and a commodity master 544. The member master 542 stores the customer information of those customers who are members of the store introduction system 10. The store master 543 stores the store information about the stores participating in the store introduction system 10. The commodity master 544 stores information about commodities.

The control unit 500 is connected to an operation unit 57 and a display unit 58 via the bus 55 and the controller 56. The controller 56 receives instructions from the control unit 500 and controls the operation unit 57 and the display unit 58. However, for convenience of description in the following, the particular control processes performed by the controller 56 may be stated as being caused, and thus performed, by the control unit 500.

The operation unit 57 is, for example, a keyboard or a touch panel. The display unit 58 is, for example, a liquid crystal display.

The control unit 500 is connected to a communication unit 59 and a communication unit 60 via the bus 55. The communication unit 59 is connected to the membership site 9 via the communication connection 25. The communication unit 60 is connected to the store server 3 via the communication connection 8.

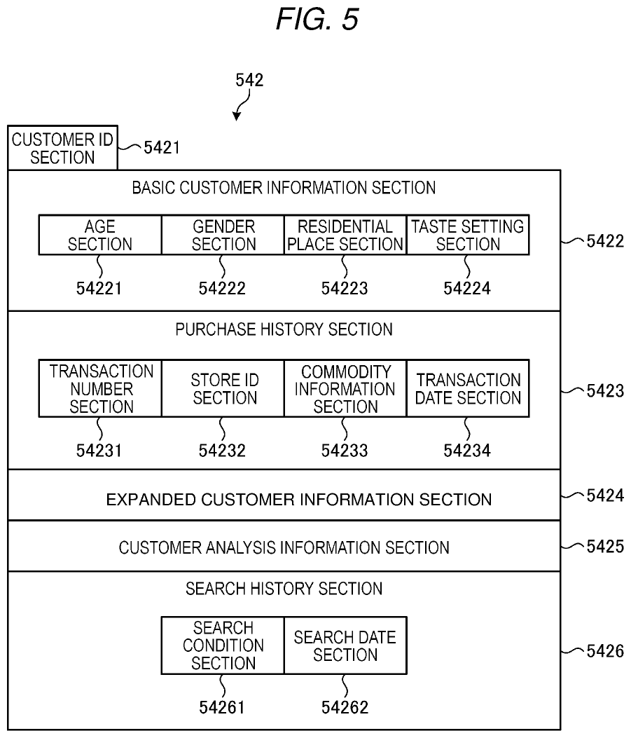

FIG. 5 is a memory map illustrating an example of a configuration of the member master 542. The member master 542 includes a customer ID section 5421, a basic customer information section 5422, a purchase history section 5423, an expanded customer information section 5424, a customer analysis information section 5425, and a search history section 5426. It is noted that, although FIG. 5 illustrates the member master 542 for just one customer, the member master 542 stores the depicted information for each customer ID registered by the store introduction system 10.

The customer ID section 5421 stores the customer ID that identifies the particular customer. The basic customer information section 5422 stores the basic customer information related to the customer ID. Specifically, in this example, the basic customer information section 5422 has an age section 54221, a gender section 54222, a residential place section 54223, and a taste setting section 54224. The age section 54221 stores the age of the customer. The gender section 54222 stores the gender of the customer. The residential place section 54223 stores the residential place (address) of the customer. The taste setting section 54224 stores such things as information about known or provided hobbies and tastes of the customer. In this example, information in the taste setting section 54224 is information input by the customer himself/herself via the mobile terminal 1.

The purchase history section 5423 stores information related to previous purchases of commodities (including services) of the customer. Specifically, in this example, the purchase history section 5423 includes a transaction number section 54231, a store ID section 54232, a commodity information section 54233, and a transaction date section 54234. The transaction number section 54231 stores the transaction number of each previous purchase (transaction) of the customer. The store ID section 54232 stores the store ID that identifies the store where a previous transaction occurred. The commodity information section 54233 stores information indicating the items that were purchased in the previous transactions. The transaction date section 54234 stores the date and time when the previous transactions occurred.

The expanded customer information section 5424 stores expanded customer information. The expanded customer information is, for example, information about the stores where the customer purchases commodities and information about the commodities purchased by the customer indicating a tendency or characteristic of the target customer himself/herself with respect to purchases of particular commodities (or types) or particular stores 2 (or types of stores). For example, the expanded customer information can be information about the stores and the commodities deemed matching or suitable the purchase tendencies of the customer himself/herself. Such information may be derived from the basic customer information and the purchase history information of the target customer, for example. For example, the expanded customer information reflects the distribution stores where the customer has shopped in the past and the commodities that were purchased by the customer. For example, the expanded customer information is generated based on the genre (type) of available commodities in the stores where the customer makes purchases. As an example, the expanded customer expansion information is obtained by acquiring the store IDs (stored in the store ID section 54232) of the stores where the customer purchased commodities listed in the purchase history and then acquiring store information associated with the store IDs. The expanded customer information may thus indicate the distribution and/or ratio of the commodity genres of the commodities sold at the relevant stores. As another example, the expanded customer information can be obtained by acquiring the commodity codes (stored in the commodity information section 54233) of the purchased commodities in the purchase history and acquiring the commodity information based on the commodity codes. The expanded commodity information may thus indicate the distribution and/or ratio of the stores where the purchased commodities were sold.

The customer analysis information section 5425 stores customer analysis information. The customer analysis information is statistical information indicating a tendency of customers having features similar to those of the target customer (established according to the purchase tendency of the target customer). For example, the customer analysis information is statistical information (for example, the age group of customers) related to “other customers” having features similar to those of the target customer or statistical information (for example, a ratio of commodity sales) related to the stores used by “other customers” and commodities to be purchased. For example, the customer analysis information is statistical information indicating the purchase tendency, tastes, or the like of other customers, which can be derived from the basic customer information and the purchase history information of other customers having features similar to those of the target customer. For example, the customer analysis information is statistical information indicating other stores often used by customers similar to the target. As an example, the customer analysis information is statistical information obtained by comparison of information related to other customer IDs (customers) who have shopped at the same store 2 as the target customer. For example, other stores or store types frequented by the other customers similar in some manner to the target customer may be determined. As another example, the customer analysis information is statistical information obtained based on commodities purchased by other customers who have shopped at a same store as the target customer.

The search history section 5426 stores a history of search parameter inputs (search conditions) used by the customer when searching for stores via the membership site 9 or the like. Specifically, in the present example, the search history section 5426 has a search condition section 54261 and a search date section 54262. The search condition section 54261 stores the search conditions that the customer input to the membership site 9. The search date section 54262 stores the date and time when the search conditions were received. It is noted, in the present example, the search history section 5426 stores all the previously received search conditions and the search date section 54262 stores a reception date and time (a date and time when the search is performed) of all the previous searches.

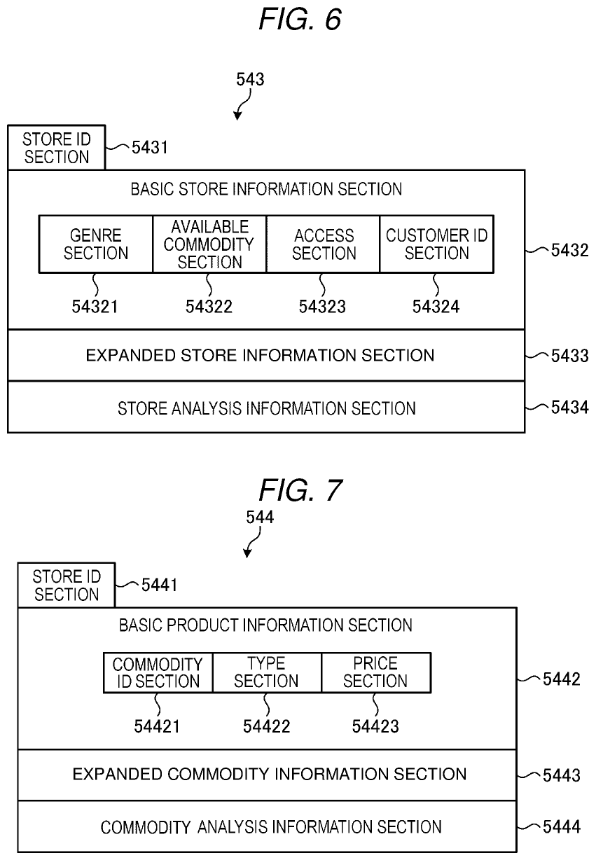

FIG. 6 is a memory map illustrating a configuration of the store master 543. As illustrated in FIG. 6, the store master 543 includes a store ID section 5431, a basic store information section 5432, an expanded store information section 5433, and a store analysis information section 5434. The store ID section 5431 stores the store ID that identifies the particular store 2.

The basic store information section 5432 stores the basic store information for the store 2. The basic store information section 5432 includes a genre section 54321, an available commodity section 54322, an access section 54323, and a customer ID section 54324. The genre section 54321 stores the genre value (as based on a portion of the store attributes or otherwise set or assessed) of the store 2. The genre or genre value may also be referred to as a store type, a store categorization, or the like. The available commodity section 54322 stores the information indicating the available commodities handled at the store 2. The access section 54323 stores the information related to accessing to the store 2 (for example, the address of the store). The customer ID section 54324 stores the customer IDs of the customers who use the store 2. The customer IDs included in the customer ID section 54324 may be limited in some manner to those who use the store 2 frequently rather than just one or a few times.

The expanded store information section 5433 stores expanded store information. The expanded store information is information indicating a characteristic of the store such the profile (distribution) of customers who use the store and types of commodities sold at the store (commodity type distribution). The expanded store information indicates a tendency of a customer to use the store and the profile of commodities handled by the store itself.

The store analysis information section 5434 stores store analysis information (additional store information). The store analysis information is statistical information indicating a similarity in various characteristics (e.g., customer demographics, product mix, location, etc.) to other stores. For example, the store analysis information includes statistical information (for example, a distribution of commodities types or sales) indicating similarity to other stores. For example, the store analysis information is information indicating a similarity between customers of a store with those of different store types, locations, or the like. Such information can be derived from basic store information and the available commodity history information of other stores.

FIG. 7 is a memory map illustrating a configuration of the commodity master 544. As illustrated in FIG. 7, the commodity master 544 includes a store ID section 5441, a commodity basic information section 5442, an expanded commodity information section 5443, and a commodity analysis information section 5444. The store ID section 5441 stores the store ID that identifies the store.

The commodity basic information section 5442 stores the information about commodities sold at the store 2. Specifically, the commodity basic information section 5442 includes a commodity ID section 54421, a type section 54422, and a price section 54423. The commodity ID section 54421 stores the commodity codes for all the commodities sold at the store 2. The type section 54422 stores types (classes) of the commodities sold at the store 2. The price section 54423 stores the prices of the commodities sold at the store 2.

The expanded commodity information section 5443 stores the expanded commodity information. The expanded commodity information indicates a tendency related to the purchase of the target commodity. Such information may be based on the number of customers (even unidentified customers) who purchase the commodity as well as information regarding the stores that sell the commodity. The expanded commodity information can be information indicating a tendency and/or an apparent taste characteristic of customers who purchase the commodity and/or information indicating a tendency or characteristic of the stores that sells the commodity. Such information may be considered to reflect a tendency characteristic related to the target commodity itself. The expanded commodity information can be information indicating a tendency of a customer to purchase the commodity or a store to handle the commodity and related to the commodity itself by the commodity code included in the commodity basic information of the target commodity. As an example, the expanded commodity information is obtained by acquiring the customer information corresponding to the acquired customers ID, and the commodities purchased by these customers and a distribution of characteristics of these customers (for example, the distribution of age groups of customers who purchase the commodity). Further, as another example, the expanded commodity information can be obtained by acquiring the customer information corresponding to the acquired customer IDs and information about the stores where these customers purchase commodities and the distribution of commodities at such stores (for example, the distribution of the available commodities at such stores).

The commodity analysis information section 5444 stores commodity analysis information. The commodity analysis information is statistical information indicating a tendency for customer who purchases one particular commodity (commodity ID or commodity type) to purchase another commodity (commodity ID or commodity type)). For example, the commodity analysis information is statistical information related to “other commodities” having features similar to those of the target commodity and statistical information related to customers who purchase these “other commodities” and the stores that handle these “other commodities”.

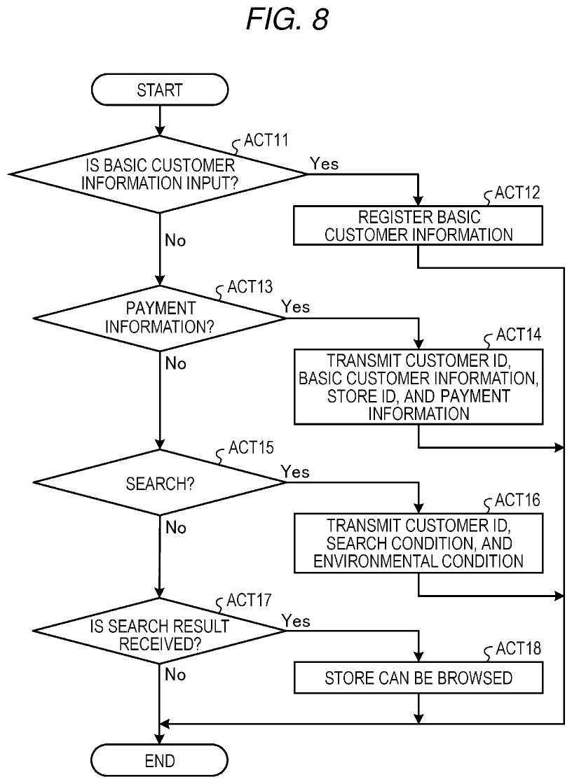

FIG. 8 is a flowchart illustrating an example of a control process of a mobile terminal 1. As illustrated in FIG. 8, the control unit 100 of the mobile terminal 1 determines whether the operation unit 17 has been used to input basic customer information (ACT11). When basic customer information is input (Yes in ACT11), the control unit 100 registers (stores) the input basic customer information in the customer data section 142 (ACT12). Then, the control unit 100 ends the process.

If basic customer information is not input (No in ACT11), the control unit 100 next determines whether payment information (including a store ID) associated with the commodity registration process and the settlement process executed by a POS terminal at a store 2 has been received from a store server 3 (ACT13). When payment information is received (Yes in ACT13), the control unit 100 transmits the customer ID stored in the mobile terminal 1, the basic customer information stored in the customer data section 142, and the store ID and the payment information received from the store server 3 to the membership site 9 (ACT14). Then, the control unit 100 ends the process. The membership site 9 receives this information and transmits this information to the data server 5.

If the payment information is not received from the store server 3 (No in ACT13), the control unit 100 next determines whether a search operation was performed (ACT15). When a search operation is performed (Yes in ACT15), the control unit 100 transmits the information related to the search (e.g., search conditions) along with the customer ID of the mobile terminal 1 and current position (or other environmental conditions) of the mobile terminal 1 to the membership site 9 (ACT16). Then, the control unit 100 ends the process. The membership site 9 receives this information and transmits the information to the data server 5.

If a search is being not entered (No in ACT15), the control unit 100 next determines whether a search result is received from the membership site 9 (ACT17). When the search result is received (Yes in ACT17), the control unit 100 permits browsing of the information regarding the stores (store list) returned by the search on the membership site 9 (ACT18). Then, the control unit 100 ends the process. If the search result is not received in ACT17 (No in ACT17), the control unit 100 ends the process.

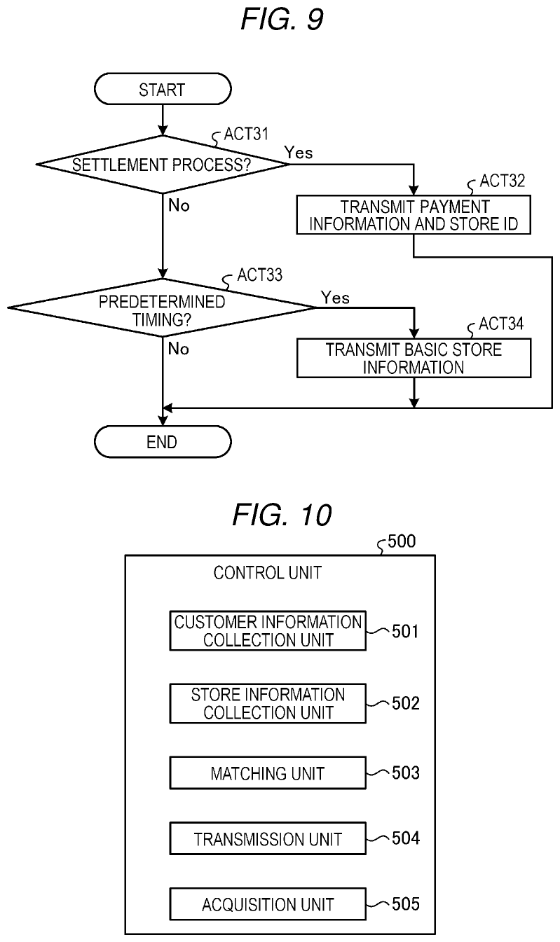

FIG. 9 is a flowchart illustrating an example of a control process of the store server 3. As illustrated in FIG. 9, the control unit 300 of the store server 3 determines whether the commodity information and the settlement information related to the settlement process related to a transaction is received from a POS terminal or the like (ACT31). When the commodity information and the settlement information are received (Yes in ACT31), the control unit 300 transmits the payment information related to the transaction together with the store ID to the mobile terminal 1 (ACT32). Then, the control unit 300 ends the process.

In addition, when the commodity information and the settlement information are not received (No in ACT31), the control unit 300 next determines whether the present time is a predetermined time (ACT33). The predetermined time may be any time, for example, in a time range after the store 2 is closed for the day. When the time is the predetermined time (Yes in ACT33), the control unit 300 transmits the basic store information stored in the store data section 342 to the data server 5 (ACT34). Then, the control unit 300 ends the process. If the time is not the predetermined time in ACT33 (No in ACT33), the control unit 300 ends the process.

FIG. 10 is a functional block diagram illustrating an example of the functional aspects of the data server 5. As illustrated in FIG. 10, the control unit 500 of the data server 5 functions as a customer information collection unit 501, a store information collection unit 502, a matching unit 503, a transmission unit 504, and an acquisition unit 505 by the CPU 51 operating according to a control program stored in the ROM 52 or the control program section 541 of the memory unit 54.

The customer information collection unit 501 collects the customer information related to the customer based on the information transmitted from the mobile terminal 1 owned by the customer. In addition, the customer information collection unit 501 collects the payment information related to commodity purchases of the customer at a store 2. Specifically, the customer information collection unit 501 stores the customer information and the payment information in the member master 542.

The store information collection unit 502 collects the information related to the commodities sold at the store 2 and the information on costumers who shop at the store 2. Specifically, the store information collection unit 502 stores the store information received from the store servers 3 in the store master 543.

The matching unit 503 performs a matching process involving extracting the store(s) corresponding to a tendency of the customer to purchase commodities based on the customer information and the store information. Specifically, the matching unit 503 performs a matching process of extracting a store having a high similarity to the attributes of the customer for which the search was performed.

The transmission unit 504 transmits the extracted information on the store. Specifically, the transmission unit 504 transmits an extracted list information of evaluated similar or matching stores to the membership site 9.

The acquisition unit 505 acquires the environmental conditions for the mobile terminal 1 requesting the search and the search parameters for the search input from the mobile terminal 1. Specifically, the acquisition unit 505 receives the information on the current position of the mobile terminal 1 and any search conditions from the membership site 9.

The matching unit 503 performs the matching process of extracting suitable stores based on the environmental condition and the search parameters acquired by the acquisition unit 505.

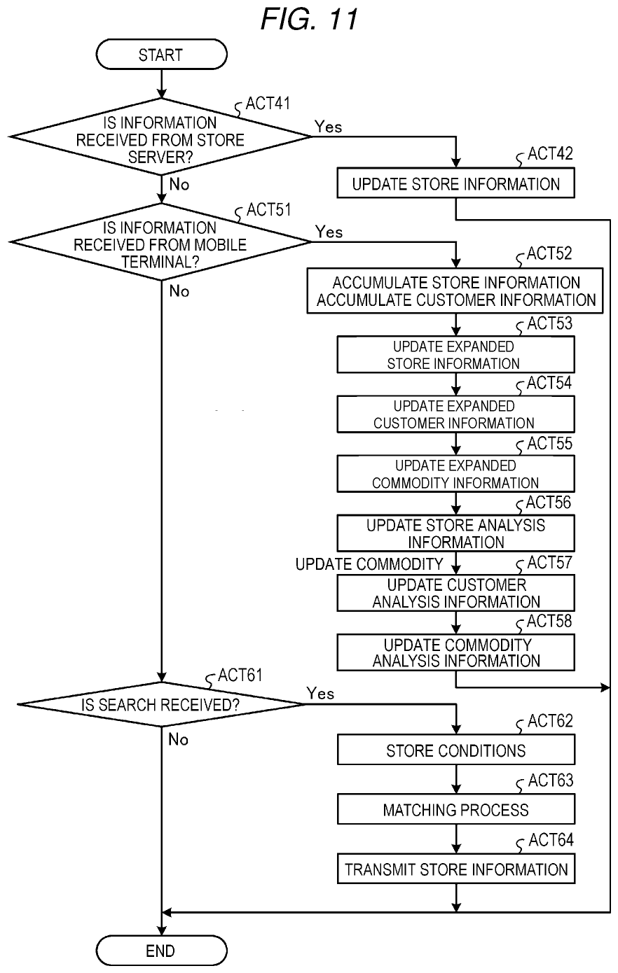

FIG. 11 is a flowchart illustrating an example of the control process of the data server 5. As illustrated in FIG. 11, the control unit 500 of the data server 5 determines whether the basic store information has been received from the store server 3 (ACT41). When basic store information is received from the store server 3 (Yes in ACT41), the store information collection unit 502 updates the store information of the store master 543 (ACT42). Then, the control unit 500 ends the process.

If basic store information is not received in ACT41 from the store server 3 (No in ACT41), the control unit 500 next whether or not information has been received from the mobile terminal 1 (ACT51). When information (e.g., customer ID, basic customer information, store ID, and payment information) is received in ACT51 from the mobile terminal 1 (Yes in ACT51), the customer information collection unit 501 adds the received information as appropriate to the member master 542 and store master 543 (ACT52).

Next, the control unit 500 updates the expanded store information stored in the expanded store information section 5433 of the store master 543 (ACT53). Specifically, the control unit 500 acquires the customers ID from the member master 542 for the accumulated payment information. Then, the control unit 500 updates the expanded store information for the store. For example, the age distribution of customers who use the store is updated.

FIG. 12 is an example of the expanded store information and is depicted as a pie chart of the distribution of the age groups of customers who use a certain store. It can be understood from FIG. 12 that this store is often used by customers in their 20's and 30's.

Next, the control unit 500 updates the expanded customer information stored in the expanded customer information section 5424 of the member master 542 (ACT54). Specifically, the control unit 500 acquires the store ID from the store ID section 54232. Then, the control unit 500 generates the expanded customer information in which the distribution of the customers is updated based on the acquired store ID. For example, the distribution of commodities sold at a store is updated based on new information.

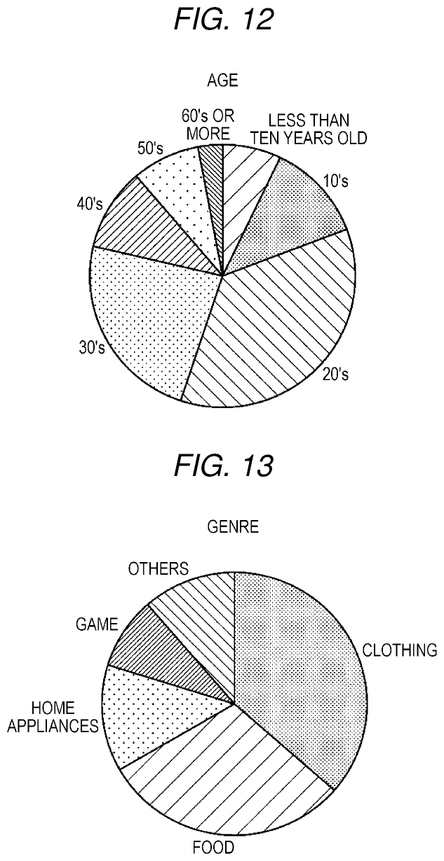

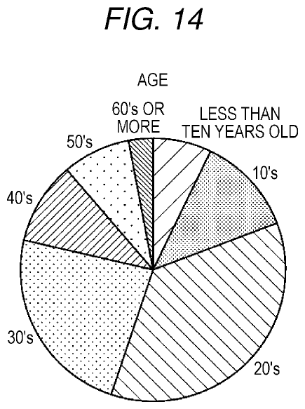

FIG. 13 is an example of the expanded customer information and is a depicted as a pie chart of the distribution of commodities (by broad category “genre”) that are sold to customers at the store identified by the store ID. It can be understood from FIG. 13 that the largest number of customers purchase clothing at this store.

Next, the control unit 500 (as the expanded commodity information update unit) updates the expanded commodity information stored in the expanded commodity information section 5443 of the commodity master 544 (ACT55). Specifically, the control unit 500 acquires the payment information by customer ID and transaction number and acquires the customer IDs of the customers who purchased a commodity based on the commodity information included in the payment information. Then, the control unit 500 acquires the customer information by customer ID and updates the distribution of the information for the acquired customers.

For example, the control unit 500 updates the expanded commodity information by updating the distribution of the age groups of customers who purchase for each commodity.

FIG. 14 is an example of the expanded commodity information and is depicted as a pie chart of the distribution of the age groups of customers who purchase a particular commodity (or commodity type). It can be understood from FIG. 14 that this commodity (or commodity type) is most often purchased by customers in their 20's and 30's.

Further, the control unit 500 generates and/or updates the store analysis information derived from the store information and the expanded store information (ACT56). Further, the control unit 500 generates and/or updates the customer analysis information derived from the customer information and the expanded customer information (ACT57). The control unit 500 generates and/or updates the commodity analysis information derived from the available commodity information and the expanded commodity information (ACT58).

In this manner, the control unit 500 performs the processes ACT52 to ACT58 to update the member master 542, the store master 543, and the commodity master 544.

Further, when the relevant information is not received from the mobile terminal 1 in ACT51 (No in ACT51), the control unit 500 next determines whether a search request or the like is received from the mobile terminal 1 (ACT61). When such is received (Yes in ACT61), the acquisition unit 505 stores the accompanying received search conditions and environmental conditions in the RAM 53 (ACT62). Then, the matching unit 503 performs a matching process (ACT63) based on the acquired search conditions, the environmental conditions, the customer information, the store information, and the commodity information.

Specifically, the control unit 500 searches the member master 542 for the received customer ID and acquires the customer information of the corresponding customer. Next, the control unit 500 extracts any stores matching the set or established search conditions and generates a store list. For example, when the search condition is a request to find a store of a type corresponding to “genre N”, a list is generated by extracting the stores with “genre N” listed in the genre section 54321. The list order may be prioritized by various factors such as known customer characteristics or purchase tendencies.

Next, the control unit 500 also acquires the location of each store on the list (from the access section 54323). Next, the control unit 500 calculates the distance between the current position of the mobile terminal 1 and each store. This set of distances is referred as data X. In this example, the lesser the distance to store, the larger the value of X for that store.

Next, for the “genre N” stores that the searching customer has previously used (purchased goods at), the control unit 500 establishes a ratio or other comparative value between customer characteristics of those previously frequented stores and the customer characteristics of the “genre N” stores on the store list from the search. For example, if the searching customer is known to be in his/her 20's, then the age group distribution of the listed stores may be compared. The comparative values indicating similarity or suitability of each listed store to the searching customer's characteristics or assessed preferences is referred to in this context as data Y. Each Y value may be a percentage determined based on the expanded store information. In this example, the higher the Y value, the greater the match to customer characteristics or preferences.

Next, the control unit 500 sets a ratio of the “stores in the genre N frequently used by the customer who frequently uses the stores” registered in the store frequently used by the searched customer as data Z (percentage data based on customer analysis information) based on the customer analysis information, the store analysis information, and the available commodity analysis information. The higher the ratio of stores used, the larger the value of Z.

Next, the control unit 500 evaluates each store for the stores listed in the generated store list associated with the search request. That is, an evaluation value=aX+bY+cZ (where a, b, and c are coefficients for weighting data X, data Y, and data Z) is calculated for each listed store.

Then, the control unit 500 ranks the stores in descending order of the evaluation values. That is, the control unit 500 extracts stores considered most likely to be useful or suitable for the searching customer and thus most likely to result in the customer purchasing a commodity. In this manner, the matching unit 503 performs the matching process in ACT63. Then, the transmission unit 504 transmits the ranked store list to the membership site 9. When the membership site 9 receives the store list, the membership site 9 notifies the customer (mobile terminal 1) of the search result. The customer receiving the notification operates the mobile terminal 1 to browse the list of stores. Then, the control unit 500 ends the process.

As described above, the data server 5 according to an embodiment includes the customer information collection unit 501, the store information collection unit 502, the matching unit 503, and the transmission unit 504.

The data server 5 according to such an embodiment extracts the store suitable for the customer based on customer attributes in the customer information and the store attributes in the store information. Therefore, it is possible to introduce the store useful to the customer without visiting the store and using the store.

### Modifications

In an embodiment, when searching for a store, the search is executed by using the acquired search conditions. However, examples are not limited thereto. In other examples, the matching process may be performed based on the customer information and the store information without using the search conditions.

In an embodiment, the formula of evaluation value=aX+bY+cZ (where a, b, c are coefficients for weighting data X, data Y, and data Z) is used. However, this formula is one example, and other formulas may be adopted in other examples.

In an embodiment, the customer analysis information is used to generate data Z based on “genre N” and search conditions. However, examples are not limited thereto. In other examples, the store analysis information or the commodity analysis information may be used to generate data Z according to the type of search condition.

In an embodiment, information is transmitted from the mobile terminal 1 to the data server 5 via the membership site 9. Furthermore, the store list is transmitted from the data server 5 to the mobile terminal 1 via the membership site 9. However, in other examples, information may be transmitted without going through membership site 9.

In an embodiment, a mobile terminal 1 is used as a terminal. However, in other examples, a PC or the like provided at home may be used in place of a mobile terminal 1.

In an embodiment, the data server 5 updates the information received from the store server 3 and the mobile terminal 1 at respective reception timings (FIG. 11). However, in other examples, the received information may be updated at any timing (for example, a predetermined time at a fixed interval).

The control program executed by the data server 5 according to an embodiment can be recorded and provided on a non-transitory, computer-readable recording medium such as a CD-ROM, a flexible disk (FD), a CDR, or a digital versatile disk (DVD) as a file in an installable format or an executable format. Likewise, the control program may be accessed, downloaded, or otherwise distributed via a network such as the Internet. The control program may also or instead be fixed into a ROM type unit or the like.

While certain embodiments have been described, these embodiments have been presented by way of example only, and are not intended to limit the scope of the present disclosure. Indeed, the novel embodiments described herein may be embodied in a variety of other forms; furthermore, various omissions, substitutions and changes in the form of the embodiments described herein may be made without departing from the spirit of the present disclosure. The accompanying claims and their equivalents are intended to cover such forms or modifications as would fall within the scope and spirit of the present disclosure.

What is claimed is:

1. A server for a store introduction system, the server comprising:
a first communication interface configured to connect to a member site server;
a second communication interface configured to connect to a plurality of store servers; and
a control unit including a processor and a memory unit, the control unit configured to:
collect customer information of a customer, the customer information being provided by the customer to the member site server or transaction related information from a store server in the plurality of store servers, the transaction related information reflecting a sales transaction of the customer at a store associated with the store server;
collect store information from the plurality of store servers, the store information indicating commodities sold at each store and customers of each store;
perform a matching process between the customer and the stores associated with the plurality of store servers based on purchase preferences of the customer indicated in the customer information and characteristics of stores indicated in the store information; and
transmit information indicating a result of the matching process to the member site server.

2. The server according to claim 1, wherein
the store information includes a physical address of each store, and
the customer information includes a present location of the customer terminal.

3. The server according to claim 1, wherein the store information includes a store ID number, a physical address, a store type code, and a list of customers who have purchased items at the store.

4. The server according to claim 3, wherein the customer information includes demographic profile information for the customer.

5. The server according to claim 3, wherein the store information includes customer demographic information indicating a distribution of customer characteristics for the store.

6. The server according to claim 3, wherein the store information includes statistical characteristics of products previously sold at the store.

7. A non-transitory, computer-readable medium storing program instructions which when executed by a processor of a server for a store introduction system causes the processor to perform a method comprising:
collecting customer information of a customer, the customer information being provided by the customer to a member site server or transaction related information from a store server in a plurality of store servers, the transaction related information reflecting a sales transaction of the customer at a store associated with the store server;
collecting store information from the plurality of store servers, the store information indicating commodities sold at each store and customers of each store;
performing a matching process between the customer and the stores associated with the plurality of store servers based on purchase preferences of the customer indicated in the customer information and characteristics of stores indicated in the store information; and
transmitting information indicating a result of the matching process to the member site server.

8. The non-transitory, computer-readable medium according to claim 7, wherein
the store information includes a physical address of each store, and
the customer information includes a present location of the customer terminal.

9. The non-transitory, computer-readable medium according to claim 7, wherein the store information includes a store ID number, a physical address, a store type code, and a list of customers who have purchased items at the store.

10. The non-transitory, computer-readable medium according to claim 9, wherein the customer information includes demographic profile information for the customer.

11. The non-transitory, computer-readable medium according to claim 9, wherein the store information includes customer demographic information indicating a distribution of customer characteristics for the store.

12. The non-transitory, computer-readable medium according to claim 9, wherein the store information includes a list of products sold at the store.

13. The non-transitory, computer-readable medium according to claim 9, wherein the store information includes statistical characteristics of products previously sold at the store.

14. A store introduction system, the system including:
a customer terminal of a customer registered as a member of a member site service;
a member site server configured to connect to the customer terminal and provide information of the member site service to the customer;
a data server connected to the member site server; and
a plurality of store servers connected to the data server, wherein
the data server includes:
a first communication interface configured to connect to the member site server;
a second communication interface configured to connect to the plurality of store servers; and
a control unit including a processor and a memory unit, the control unit configured to:
collect customer information of a customer, the customer information being provided by the customer to the member site server or transaction related information from a store server in the plurality of store servers, the transaction related information reflecting a sales transaction of the customer at a store associated with the store server;
collect store information from the plurality of store servers, the store information indicating commodities sold at each store and customers of each store;
perform a matching process between the customer and the plurality of stores associated with the plurality of store servers based on purchase preferences of the customer indicated in the customer information and characteristics of stores indicated in the store information; and
transmit information indicating a result of the matching process to the member site server.

15. The system according to claim 14, wherein the store information includes a physical address of each store, and the customer information includes a present location of the customer terminal.

16. The system according to claim 14, wherein the store information includes a store ID number, a physical address, a store type code, and a list of customers who have purchased items at the store.

17. The system according to claim 16, wherein the customer information includes demographic profile information for the customer.

18. The system according to claim 16, wherein the store information includes customer demographic information indicating a distribution of customer characteristics for the store.

19. The system according to claim 16, wherein the store information includes statistical characteristics of products previously sold at the store.
